(19) United States
(12) Patent Application Publication
(10) Pub. No.: US 2011/0184659 A1
(43) Pub. Date: Jul. 28, 2011

(54) METHODS FOR ASSESSING THE MISCIBILITY OF COMPOSITIONS

(76) Inventors: Simon Bates, West Lafayette, IN (US); Ivanisevic Igor, West Lafayette, IN (US); Chen Ping, West Lafayette, IN (US)

(21) Appl. No.: 12/920,049

(22) PCT Filed: Feb. 10, 2009
(86) PCT No.: PCT/US09/33700

§ 371 Date: Apr. 18, 2011

Related U.S. Application Data
(60) Provisional application No. 61/064,364, filed on Feb. 29, 2008.

(51) Int. Cl. G06F 19/00

(52) U.S. Cl. 702/27

(57) ABSTRACT

The invention relates to methods for analyzing the miscibility of compositions. The methods may further quantify the degree of miscibility of the compositions.

This application claims priority to U.S. Provisional Patent Application No. 61/064,364, filed Feb. 29, 2008.

### TECHNICAL FIELD

The invention described herein relates to methods for analyzing the miscibility of compositions, such as, for example, amorphous dispersions, by extracting information for individual components of the amorphous dispersion directly from measured analytical data using a Pure Curve Resolution Method. The methods may further quantify the degree of miscibility of the compositions by a nearest neighbor refinement method.

### BACKGROUND

Pharmaceuticals are often formulated from crystalline compounds because crystalline materials typically provide high levels of purity and are resistant to physical and chemical instabilities under ambient conditions. Unlike a crystalline solid, which has an orderly array of unit cells in three dimensions, an amorphous form lacks long-range order because molecular packing is more random. As a result, amorphous organic compounds tend to have different properties than their crystalline counterparts. For example, amorphous compounds tend to have greater solubility than crystalline forms of the same compound (see, e.g., Hancock and Parks, Pharmaceutical Res. 17, 397 (2000)). Thus, for example, in pharmaceutical formulations whose crystalline forms are poorly soluble, amorphous forms often present attractive formulation options. As such, amorphous active pharmaceutical ingredients (API) are often used to improve physical and chemical properties of drugs, such as, for example, dissolution and bioavailability.

Because crystalline forms are more thermodynamically stable than amorphous forms, there is a driving force toward crystallization of the amorphous state for any given compound or mixtures of compounds. Therefore, when preparing amorphous drug products, it is often desirable to prepare a composition of the active pharmaceutical ingredient with an excipient that stabilizes the amorphous state against crystallization. Such stabilizing excipients may be selected from, for example, polymers, celluloses, and organic acids. Exemplary stabilizing excipients include polyvinylpyrrolidone (PVP), hydroxypropylmethyl cellulose (HPMC), and citric acid, to name a few. Those of ordinary skill in the pharmaceutical arts will recognize that there are numerous other excipients capable of stabilizing amorphous APIs against crystallization. These excipients are also meant to be included within the definition of “stabilizing excipient” as that term is used herein.

Intimate mixing, such as mixing at the molecular level (e.g. in a solution), between such stabilizing excipients (e.g. polymers) and an amorphous API is an important factor in order for the composition to remain resistant to crystallization. These compositions are considered miscible molecular dispersions as opposed to phase-separated mixtures or phase-separated compositions of two amorphous solids. However, miscibility may be difficult to achieve and further may be difficult to determine whether it was achieved. As such, there may be a lack of confidence that the formulated composition will prevent crystallization and retain the desired performance attributes during the shelf life of a drug product. It may be desirable, therefore, to have a method by which one can analyze a composition to determine whether miscibility has been achieved and/or maintained.

One known approach to analyzing compositions comprising at least two amorphous components for miscibility involves measuring the glass transition temperature (T_{g}) using differential scanning calorimetry (DSC). A fully miscible system should exhibit a single T_{g} with a value somewhere between the glass transition temperatures of the two individual amorphous components. Two glass transition temperatures should be indicated in the case of a fully phase-separated composition, one for each individual component. However, a partially miscible composition may still give two T_{g} values, though they may differ from that of each individual component. One drawback with this approach is that the resolution of DSC may require that the glass transition temperatures for each individual component be at least about 10° C. apart. In addition, the size of the phase-separated domains should be large enough (e.g. greater than about 30 nm) to detect by DSC. Because of these drawbacks, it is possible to detect a single T_{g} in a phase-separated composition, leading to an incorrect conclusion that the composition is fully miscible. An additional concern with the use of DSC is the requirement that the sample be heated, which may cause a binary (i.e. phase-separated) composition to become miscible, thus leading to an incorrect interpretation of the DSC results.

Another known approach utilizes computational methods for analyzing amorphous composition using x-ray powder diffraction (XRPD) data. See, e.g., A. Newman, D. Engers, S. Bates, I. Ivanisevic, R. Kelly, and G. Zografi, J. Pharm. Sci., 97 (11), pp. 4840-4856 (2008). One of these computational methods is based on the modeling of compositions containing amorphous components as a linear combination of individual reference patterns and comparing the calculated pattern to measured data to determine a goodness of fit. When linear combinations of the reference patterns accurately describe measured powder patterns of the compositions with scale factors that are correlated to the known weight percents, the composition can be considered phase-separated. Otherwise, it is potentially miscible.

One limitation of the XRPD technique for analysis of amorphous materials is the length scale coherently probed in the sample. The length scale can be determined by any method known in the art, for example it may be estimated from the widths of the amorphous halos, for example using Scherrer's equation. When there is significant disorder present in the sample, the length scale is approximately 1 to 2 nm. This may result in a miscible composition with structural features greater than the critical length scale which will appear to be phase-separated. This may be an important consideration for large molecules. A further limitation of the linear powder pattern combination approach may be seen when the x-ray amorphous powder patterns of the API and polymers are very similar, which is not uncommon for small molecule amorphous API and typically used polymers.

Another computational method involves a novel approach that is based on the use of Pair Distribution Function (PDF) data derived from XRPD patterns, rather than the patterns themselves. The transformation of the powder data to a PDF representation gives a method that is more sensitive to the subtle differences between the reference patterns and can be successfully used to determine dispersion miscibility when the API and polymer reference patterns are very similar. The PDF approach has the additional advantage that the residual trace produced by the analysis procedure gives direct information as to the nature of the new API-polymer intermolecular interactions that appear as a result of miscibility. However, the PDF approach may, in some cases, be sensitive to the quality of the measured data and/or the presence of experimental artifacts (e.g. instrument or sample holder backgrounds and air scatter), requiring longer measurement times than is typical of most routine XRPD experiments.

The above techniques have advantages and drawbacks. For example, the methods require representative measured data for the amorphous API and polymer. For some API systems with low glass transition temperatures, it can be difficult to obtain a pure reference x-ray amorphous powder pattern of the API. Furthermore, some polymers, such as PVP, tend to give variable x-ray amorphous signatures depending on the sample preparation method used. Without pure-phase reference patterns that represent the diffraction response of the API and polymer within the dispersion, it may not be possible to develop a working method to determine miscibility using the above-described computational methods. Finally, these methods may not be able to give sufficient information regarding the degree of miscibility and/or the potential for recrystallization.

The methods of the present invention, in at least some exemplary embodiments, use a two-step approach to analyze a composition, such as an amorphous dispersion. In a first step, in order to determine whether the composition is miscible or phase-separated, a pure curve resolution method (“PCRM”) is used to extract information for the individual components directly from measured data, such as, for example, XRPD, infrared (IR), solid-state nuclear magnetic resonance (NMR), or Raman data. In the PCRM method, the variance between a series of powder patterns collected on binary compositions can be used to identify the number of variance components that characterize the set of mixed powder patterns. Each of these variance components can be projected back into a corresponding reference powder pattern or pure curve. For a binary composition, two of the reference powder patterns derived by PCRM should correspond to the polymer and API. For a phase-separated composition there should be no other significant components contributing to the variance. For miscible compositions, it is possible that additional significant contributions to the variance will be identified, allowing the generation of x-ray amorphous powder patterns corresponding to the new API-polymer molecular interactions.

In the case where the composition is identified as being miscible, a second step utilizes an nearest-neighbor refinement method, such as, for example, an alternating least squares (“ALS”) technique, to determine the degree of miscibility, and thus the potential for re-crystallization.

Although the present invention may obviate one or more of the above-mentioned disadvantages, it should be understood that some aspects of the invention might not necessarily obviate one or more of those disadvantages.

In the following description, various aspects and embodiments will become evident. In its broadest sense, the invention could be practiced without having one or more features of these aspects and embodiments. Further, these aspects and embodiments are exemplary. Additional objects and advantages of the invention will be set forth in part in the description which follows, and in part will be obvious from the description, or may be learned by practicing of the invention. The objects and advantages of the invention will be realized and attained by means of the elements and combinations particularly pointed out in the appended claims.

### SUMMARY

In accordance with various exemplary embodiments of the invention, the inventors have discovered novel computational methods for analyzing compositions. Such methods comprise: (1) extracting information for individual components of a composition from measured analytical data, (2) using a pure curve resolution method to generate resulting data; and (3) analyzing the resulting data by a nearest neighbor-refinement algorithm to determine the nearest neighbor (“NN”) coordination number for the components of the composition. The nearest neighbor coordination number may then act as a value representing the degree of miscibility of the composition. The methods may be used with a variety of analytical techniques, such as, for example, XRPD, IR, NMR, and Raman spectroscopy. The methods may be useful for identifying phase-separated compositions and differentiating them from miscible compositions. In at least one embodiment, the methods may be useful for determining the degree of miscibility of amorphous compositions or amorphous dispersions.

In an exemplary embodiment of the invention, methods for determining the miscibility of a composition may comprise (a) obtaining analytical data on a composition, such as, for example, XRPD, IR, NMR, or Raman data, on compositions comprising two or more components, such as at least one amorphous API and at least one stabilizing excipient, (b) obtaining analytical reference data, such as pure reference XRPD, IR, NMR, or Raman data, for each of the two or more components, and (c) applying a pure curve resolution method to the analytical data collected on the composition, such as XRPD, IR, NMR, or Raman data to generate resulting data. The resulting data may then (d) be evaluated and a determination made regarding whether the composition is miscible or phase-separated. If the system is miscible, methods for determining the degree of miscibility may comprise (e) evaluating the data using a nearest-neighbor refinement method.

Various exemplary embodiments may also include further processing the data to smooth any noise present and de-resolve the data to an appropriate number of points, normalizing the data (for example so that the sum of total intensity in each XRPD pattern is the same), removing any background due to instrument, sample holder, or air scatter, and applying a computational preprocessing method to the analytical composition and reference data, such as XRPD, IR, NMR, or Raman data to generate data on the compositions. Such computational preprocessing methods are known to those of ordinary skill in the art. After these steps, or various combinations thereof, have been performed, these data can then be evaluated and a conclusion made as to whether the composition is miscible or phase-separated.

The term “amorphous” in the pharmaceutical arts is often meant to describe a material which is completely randomly oriented in the solid phase. That definition is overly restrictive with respect to the invention described herein. As used herein, the term “amorphous” means, for example when applied to the API or excipient components of a composition to be analyzed according to the methods of the invention, that the x-ray powder diffraction pattern of such a component would yield a “halo” often referred to as an “amorphous halo” as that term is generally used by those of ordinary skill in the x-ray powder diffraction arts. Such a halo is significantly wider than peaks found in a pattern of a crystalline compound and indeed, may take up the majority of the angles scanned. Such a halo may be indicative of a completely randomly oriented solid, but it may also be indicative of a nanocrystalline material or other disordered solid which does have some degree of order, but on a smaller scale than that of a crystalline material. As used herein, the term “x-ray amorphous” means a material whose diffraction pattern exhibits one or more amorphous halos. As used herein, the terms “x-ray amorphous” and “amorphous” are synonymous unless otherwise specified.

As used herein, the term “pure” means representative of one component. However, a mixture or composition which contains additional component(s) in sufficiently low amounts such that the additional component(s) will not affect the results of the methods described herein will be considered “pure” for purposes of the invention. By way of example only, in a method using XRPD to obtain data on the systems being studied, an additional component may be present in a sample in an amount that is below the level of detection of the XRPD instrument and the sample may still be considered pure.

As used herein, the term “data set” means a collection of data points, each consisting of a position and intensity, as provided by and appropriate to each spectroscopic technique.

As used herein, the term “dispersion” means a composition comprising at least one amorphous API and at least one stabilizing excipient. In various embodiments of the invention, the at least one stabilizing excipient is amorphous. Dispersions may be analyzed by the methods of the invention, for example, to determine whether the dispersions are phase separated or miscible and, if miscible, the degree of miscibility.

As used herein, the term “polymer” may be used with regard to the stabilizing excipients of the composition; however, it is to be noted that other stabilizing excipients—in addition the ones expressly disclosed herein—are also contemplated within the scope of the invention.

For purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any measured numerical value, however, inherently contains certain errors necessarily resulting from the standard deviation found in their respective testing measurements. Moreover, all ranges disclosed herein are to be understood to encompass any and all subranges subsumed therein. For example, a range of “less than 10” includes any and all subranges between (and including) the minimum value of zero and the maximum value of 10, that is, any and all subranges having a minimum value of equal to or greater than zero and a maximum value of equal to or less than 10, e.g., 1 to 5, 0 to 9, etc.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Additional objects and advantages of the invention are set forth in the following description. Both the foregoing general summary and the following detailed description are exemplary only and are not restrictive of the invention as claimed. Further features and variations may be provided in addition to those set forth in the description. For instance, it will be noted that the order of the steps presented need not necessarily be performed in that order in order set forth herein to practice the invention, and some steps may be changed or omitted all together.

### BRIEF DESCRIPTION OF THE DRAWINGS

The following figures, which are incorporated in and constitute a part of the specification, serve to further illustrate several exemplary embodiments of the invention. The figures are not, however, intended to be restrictive of the invention, as claimed.

FIG. 1 shows an overlay of the first extracted pure reference curve, compared to the measured reference pattern of x-ray amorphous indomethacin, of Example 1.

FIG. 2 shows an overlay of the second extracted pure reference curve compared to the reference pattern of x-ray amorphous polyvinylpyrrolidone of Example 1.

FIG. 3 shows an overlay of the second extracted pure reference curve, compared to the (preprocessed) measured reference pattern of x-ray amorphous indomethacin of Example 2.

FIG. 4 shows an overlay of the first extracted pure reference curve compared to the reference pattern of x-ray amorphous polyvinylpyrrolidone of Example 2.

FIG. 5 shows solid lines corresponding to the concentrations of polyvinylpyrrolidone, indomethacin, and the polyvinylpyrrolidone-indomethacin mixture in seven dispersion samples obtained from ALS analysis. The dash lines are the concentration of polyvinylpyrrolidone, indomethacin, and an polyvinylpyrrolidone-indomethacin mixture calculated using the miscibility model and NN coordination numbers 1 and 1 for polyvinylpyrrolidone and indomethacin, respectively.

FIG. 6 shows solid lines representing the measured data for compositions of the mixtures as given and the dotted lines represent calculated lines using concentration profiles and XRPD patterns from the ALS analysis. The individual data sets are clearly resolved at the first PVP halo at about 12°2θ.

FIG. 7 shows reference patterns for amorphous polyvinylpyrrolidone, indomethacin, and the unknown component of Example 2, extracted using ALS analysis, and two measured reference patterns for comparison.

FIG. 8 shows an overlay of a measured XRPD pattern of x-ray amorphous dextran (DEX) and a calculated XRPD pattern of a second pure reference curve, extracted from a set of mixtures of DEX and PVP.

FIG. 9 shows an overlay of a measured XRPD pattern of x-ray amorphous DEX and a calculated XRPD pattern of a first pure reference curve, extracted from a set of mixtures of DEX and PVP.

FIG. 10 shows an overlay of a measured XRPD pattern of x-ray amorphous DEX and a calculated XRPD pattern of a second pure reference curve, extracted from a set of dispersions of DEX and PVP.

FIG. 11 shows an overlay of a measured XRPD pattern of x-ray amorphous PVP and a calculated XRPD pattern of a first pure reference curve, extracted from a set of dispersions of DEX and PVP.

FIG. 12 shows an overlay of a measured XRPD pattern of x-ray amorphous DEX and a calculated XRPD pattern of a first pure reference curve, extracted from a set of dispersions of DEX and trehalose (TRE).

FIG. 13 shows an overlay of a measured XRPD pattern of x-ray amorphous TRE and a calculated XRPD pattern of a second pure reference curve, extracted from a set of dispersions of DEX and TRE.

### DESCRIPTION OF EXEMPLARY EMBODIMENTS

Reference will now be made in greater detail to exemplary embodiments of the invention. It is to be understood that both the foregoing general description and following detailed description are exemplary and explanatory only, and are not to be interpreted as restrictive of the invention as claimed.

In various exemplary embodiments of the invention, methods for determining whether a composition comprising two or more components is miscible may comprise (a) obtaining analytical data collected on the composition, (b) obtaining analytical reference data for each of the two or more components of the composition, (c) applying a pure curve resolution method to the analytical data collected on the composition and to the reference data to generate results, and (d) evaluating the resulting data to determine whether the composition is miscible or phase-separated. If the system is miscible, methods for determining the degree of miscibility may comprise evaluating the data using a nearest-neighbor refinement method, such as, for example, an alternating-least squares analysis.

In at least one embodiment, the methods comprise a two-step approach for analyzing whether a composition, such as a composition comprising an amorphous API and at least one stabilizing excipient, is miscible, and if so, the degree of miscibility, comprising using a pure curve resolution method analysis to generate pure reference curves followed by an alternating least squares analysis of the pure reference curves.

In one exemplary embodiment of the invention, the pure curve resolution method analysis uses at least one set of analytical data collected on the composition comprising at least one amorphous API and at least one stabilizing excipient, such as, for example, XRPD, IR, NMR, or Raman data. In a further exemplary embodiment, analytical reference data for the pure API and the pure stabilizing excipient in the composition may also be used. In another exemplary embodiment, at least two or more sets of analytical data collected on the composition comprising at least one amorphous PI and at least one stabilizing excipient are used, and in one exemplary embodiment two or more such compositions comprising of differing ratios of API to polymer may be analyzed. In other exemplary embodiments it may be possible to use the analytical reference data for pure components as additional “compositions” thereby proceeding with only one set of data for the composition comprising the at least one amorphous API and the at least one stabilizing excipient itself, although some of the robustness of the pure curve resolution method approach may be lost in some instances with this approach. In other exemplary embodiments, a polymer-rich composition and/or an API-rich composition may be included among the measured sets of data.

In further exemplary embodiments, the methods of the invention can be used with reference data from a single component on data where the compositions contain roughly symmetric loadings of components with as little as two measured compositions (e.g. 30:70 and 70:30 API:polymer). In yet further exemplary embodiments where the loadings are asymmetric (e.g. 60:40 and 70:30 API:polymer), three or more measured patterns (optionally all at different loadings, e.g. 60:40, 70:30, 80:20) may be desirable.

The analytical dispersion data and analytical reference data used in various exemplary embodiments of the invention can be obtained by any method known to those skilled in the art of, for example, XRPD, IR, NMR, Raman, or other analytical techniques used according to the invention. In many exemplary embodiments, XRPD data are used.

Since PCRM is a relative method based upon the observed variance in the data between data collected on different dispersions, in certain exemplary embodiments variances in the analytical data not due to the structural differences between the dispersions may be minimized as part of the experimental method. Accordingly, consistent sample preparation and data collection may also be desired in certain exemplary embodiments.

Furthermore, in some exemplary embodiments where XRPD data are used, variable contributions to the measured analytical data extraneous to the sample XRPD diffraction may be removed through data pre-processing applied to either or both the analytical reference data and the data collected on the dispersion. For example, for data collected using XRPD in reflection geometry this may include, inter alia, removal of the main beam contribution, removal of the instrument background, and noise suppression.

With regards to the methods of the invention, when using XRPD, for example, if the data collection step size is much smaller (for example an order of magnitude smaller) than the widths of the x-ray amorphous halos, then removal of the random noise (counting statistics) should be straightforward and can be achieved using any standard approach such as, for example, Savitsky-Golay or digital filter data smoothing, or other techniques known to those of skill in the art. An additional pre-processing step that may be optionally applied in some embodiments is data compression that effectively reduces the few thousand data points to less than 100 data points. For example, with x-ray amorphous materials, the halo widths are typically a few hundred data points wide, allowing relatively aggressive data compression. Different or additional data pre-processing steps known to those skilled in the art may also be used, and which steps and whether such pre-processing steps should be used is well within the knowledge of those skilled in the art.

Optionally, the various data sets can be interpolated to a common range and step size during the pre-processing. In various exemplary embodiments of the invention applying the methods to XRPD data, for example, the pre-processed data may optionally be scaled to force the integrated intensities of the different pre-processed powder patterns to be equal. In one exemplary embodiment, the XRPD data collection step size in 2θ for the reflection measurements can be any step size used in a diffraction system. The step size may be in the range of, for example, about 0.01°2θ to about 0.2°2θ, such as about 0.02°2θ to about 0.05°2θ or about 0.035°2θ to about 0.05°2θ. In one exemplary embodiment, the step size may be about 0.02°2θ. Such step size ranges are considerably smaller than the amorphous halo widths that are typically greater than 5°2θ. This large difference may allow for excellent noise reduction during pre-processing without compromising the information content of the data.

In various exemplary embodiments, it may be desirable to minimize background contributions and to collect high quality analytical reference and dispersion data possible with the available system, such as, for example, the XRPD, IR, NMR, or Raman data. For example, in one embodiment, while collecting XRPD data a helium purge can be used to minimize air scatter, and sample holders that introduce additional x-ray amorphous material into the measurement (such as, for example, glass or plastics) can be avoided.

According to various exemplary embodiments of the first step of the present invention, the analytical reference and dispersion data are obtained and then an algorithm is applied to the data collected, for example the x-ray powder patterns. In the algorithm, each intensity point, d, in the dispersion data is treated as a variable. In at least one embodiment, the PCRM is only applied to the dispersion data.

In applying the PCRM algorithm, each set of analytical reference and dispersion data obtained is a “case,” resulting in a data matrix D of dimensions (m)×(n), where the variable (m) is the number of cases and the variable (n) the number of points in each case (variables) and d_{i,j} is an element of the matrix. For example, in an embodiment where the analytical technique used is XRPD, the x-ray patterns themselves are the cases and the data matrix is (m)×(n), with (m) being the number of patterns and (n) being the number of points in each pattern. Initially, the mean of each variable, (μⱼ, may be calculated as follows, where (i) represents the cases and (j) represents the data points in each case:

$${μ}_{j} = \frac{1}{m} {\sum }_{i = 1}^{m} {d}_{i , j} \qquad ( 1 )$$

Next, d*_{i,j} (the mean-centered intensity) can be calculated by subtracting the mean of each variable:

d*_{i,j}=d_{i,j}−μ (2)

Subsequently, the standard deviation (σⱼ) may be calculated for each d*:

$${σ}_{j} = \sqrt{\frac{{\sum }_{i = 1}^{m} {( {d}_{i , j}^{*} )}^{2}}{m - 1}} \qquad ( 3 )$$

The methods may then enter the following refinement loop:

Step 1: For the first iteration only, calculate the maximum standard deviation of σⱼ according to equation (3) and select the data points (j) associated with that maximum.

Step 2: In this step, the first thing done is to calculate a correlation coefficient as discussed below. Then, for a small (for example, about 1-11, including about 3-11, and further including about 3-5, depending on the step size after compression) window of data points (j) around this maximum, test each point as being the best representative of a pure reference curve (“PRC”). Select the one that best meets the goodness of fit criteria, for example by utilizing a least squares minimization of the difference between the back-calculated pattern corresponding to this PRC and measured data, and use it to calculate a set of data points (such as an XRPD pattern) for that PRC. Such least squares minimization techniques are well known to those of ordinary skill in the art.

Step 3: Remove the σⱼ associated with the last PRC from the remaining σⱼ.

Step 4: Compute the ratio of remaining σⱼ to initial σⱼ, using equation 3, and stop when the ratio is small, such as up to about 0.2 or more, for example from about 0.01 to about 0.2, or for example less than about 0.1, meaning about 90% of σ has been described by the PRCs detected so far.

One of ordinary skill in the art will understand that as used in step 4, the term “small” is a relative term that describes a ratio that is sufficiently small such that the method does not continue identifying PRCs. In other words, one of ordinary skill in the art will appreciate when the ratio is small upon practicing the invention, and the above exemplary numeric descriptions of a small ratio are given for purposes of understanding the approximate ratios that may be encountered upon practicing the invention.

In step 2, the PRC is computed by first calculating the correlation coefficients for every variable with respect to the variable chosen as the PRC:

$$Correl ( {d}_{i , j}^{*} , {d}_{i , PC}^{*} ) = \frac{{\sum }_{i = 1}^{m} ( {d}_{i , j}^{*} * {d}_{i , PC}^{*} )}{\sqrt{{( {d}_{i , j}^{*} )}^{2} {( {d}_{i , PC}^{*} )}^{2}}} \qquad ( 4 )$$

where d*_{i,PC} is the variable associated with the PRC. Subsequently, the σⱼ associated with this PRC can be calculated:

σ_{f}(PRC)=σⱼ*(Correlⱼ+1)/2 (5)

The set of data points, such as the XRPD pattern, associated with the PRC can be calculated:

$${y}_{j} = {μ}_{j} - {s}_{k} * ( {σ}_{j} ( {PRC}_{k} ) - {\sum }_{i = 1 , i \neq k}^{l} {σ}_{j} ( {PRC}_{i} ) ) \qquad ( 6 )$$

where (sₖ) is a scale factor associated with the k^{th} PRC and (l) is the total number of PRCs detected. The scale factors may depend on the range of relative weight percents represented by the analyzed dispersions and may be obtained by methods known to those skilled in the art. For example, in one embodiment the scale factors may be obtained by minimizing the sum squared difference between the calculated XRPD patterns of the PRCs and the reference patterns for the API and polymer (the same minimization may also optionally be used to determine the exact position of each PRC, step 2).

In an exemplary embodiment where only a single set of reference data points, such as a single XRPD pattern, exists for the dispersion, the scale factors for both pure reference curves may optionally be determined by fitting the single analytical dispersion data, such as where the composition range for the analyzed dispersions is symmetric (e.g. 80:20+20:80). In an exemplary embodiment where no reference data points are available, the pure reference curve scale factors may, for example, be derived when the miscibility is determined by fitting the measured data of the dispersions by any method known to those of skill in the art.

After the algorithm has been applied, the data may then be evaluated to determine whether the dispersion is miscible or phase-separated by determining whether the data calculated for the pure reference curve agrees with that of the individual components and/or whether a significant additional pure reference curve appears. If the data agree, the dispersion is considered to be phase-separated. If the data do not agree, or if a significant additional pure reference curve appears, the dispersion is considered to be miscible. Techniques for determining such agreement are known to those skilled in the art and any such technique may be used, such as, for example, visual matching, use of a sum squared difference approach, and/or use of a pattern matching program, such as, for example, disclosed in U.S. Patent Application Publication No. 2004/0103130.

The term “agrees with” is a relative one and is used in this application in the context of comparing data set patterns to determine how close the data set patterns match. The closer the match, the more the dispersion data set represents a phase separated system. A more miscible system will exhibit less of a match. Thus, the degree of miscibility may be assessed by looking at the closeness of match.

The following explanation is only intended to be elucidatory of the methods for evaluating data, such as XRPD data, and is not meant to be limiting of the invention as claimed. For example, the methods of the invention can also be applied to various other types of data, such as NMR data, Raman data, IR data, etc.

With regard to x-ray data, XRPD probes the mean structural relationships in the sample system at the atomic and molecular level. The structural relationships probed by XRPD are related to the physical proximity of the various molecular components and are not directly related to any specific chemical bonding. For organic molecular amorphous materials, XRPD is primarily only probing nearest neighbor (“NN”) inter-molecular and individual intra-molecular structural relationships. There are two well-defined NN inter-molecular relationships in a phase-separated composition of an API and a stabilizing excipient such as a polymer: relationships corresponding to (1) API-API and to (2) polymer-polymer interactions. Thus, in the case of a phase-separated binary composition, the contribution of these two inter-molecular diffraction components to a measured XRPD pattern may scale according to the weight percent of the two components in the mixture.

In such a phase-separated binary composition, the PCRM approach outlined above yields two orthogonal pure reference curves accounting for most, if not all, of the variance seen in the data above the noise level. As the binary composition tends toward miscibility, the NN inter-molecular interactions become more complex. In the simplest case, this leads to a third inter-molecular relationship; the API-polymer molecular interaction. This third inter-molecular interaction may not appear as a well-defined third pure reference curve even if the diffraction contribution from this new structural relationship is clearly distinct. When the degree of miscibility is strongly correlated to a binary composition, the variance introduced by the appearance of the third inter-molecular interaction can be folded into the two original orthogonal pure reference curves. In this case, the pure reference curve patterns generated by the methods outlined above will not be in agreement with or will be a poor fit to the original measured reference patterns for the amorphous API and polymer.

In various embodiments, the amorphous form of a pure API may be unstable, for example at ambient conditions, thus making it difficult to obtain a powder pattern of the pure API component. However, by forming a phase-separated solid dispersion of the API with a suitable excipient, such as a polymer, the PCRM approach may be used to extract the pure amorphous API powder pattern. Thus, the ability of PCRM to extract pure reference curves from a series of solid dispersions may, in some embodiments, allow one of skill in the art to determine an API amorphous reference pattern for certain API compositions, such as those with glass transition temperatures near or below ambient conditions.

In various exemplary embodiments of the invention, when applying the PCRM approach, one or more guides may be used to assist in determining whether a dispersion system is phase-separated or miscible, such as the following:
1) A binary phase-separated composition will be expected to have two pure components that describe substantially all of the variance in the measured data, such as powder patterns;
2) When reference data, such as powder patterns, of the pure amorphous API and/or stabilizing excipients (e.g. polymer) are available, the individual pure components isolated by PCRM should closely match the measured reference data if the composition is phase-separated; and/or
3) The measured data, such as powder patterns or PDFs, for a phase-separated system should give scale factors for the two components directly related to the known weight percents of the API and polymer in each dispersion.

In an exemplary embodiment where no pure phase amorphous reference data are available, it may still be possible to determine whether a dispersion is phase-separated by analyzing the measured dispersion data, such as XRPD patterns, using the extracted pure reference curves generated by the PCRM. In this case, the pure reference curve scale factors may be directly correlated to the known weight percents of the API and excipient present in the dispersion.

In various exemplary embodiments of the invention, a second step of the methods of the invention comprises analyzing dispersions by application of a nearest-neighbor refinement method. In at least certain exemplary embodiments, such a method is an alternating least squares (ALS) method. Further, in at least certain exemplary embodiments, the ALS technique may provide information regarding whether a dispersion is phase-separated or miscible, and further may provide information regarding the degree of miscibility of the dispersion.

By way of example, in an embodiment using XRPD data in the methods of the invention, the x-ray amorphous powder pattern measured for a single phase material may represent a cluster of molecules characteristic of that phase. In one illustration, for example, a cluster of molecules may be on the order of one to two nanometers in size. Therefore, in this illustration of a single phase, where there are very few molecules, interactions are limited primarily to nearest neighbors.

Where there are two pure phases, A and B, mixed as a binary composition and the characteristic molecular clusters of type A and type B are undisturbed by the mixing process, then the x-ray diffraction data will be expected to be characteristic of a phase-separated composition. In such a phase separated composition, phase A would be expected to have other A molecules as nearest neighbors. Likewise, phase B would be expected to have other B molecules as nearest neighbors. There could, however, be interactions between domains of A and B. Where the physical domain sizes of the clusters of type A and B are as small as one or two nanometers, as in the illustration above, there may be significant A-B interaction across the domain interfaces. However, unless this cross-domain A-B interaction exhibits a specific and reproducible physical relationship between the A type and B type clusters, no new contribution to the measured powder pattern will be expected.

As a binary composition of an amorphous API and a stabilizing excipient such as a polymer becomes miscible however, new API-polymer molecular interactions may form within the coherent nearest-neighbor (“NN”) length scale probed. For example, in an embodiment where the data is acquired by XRPD, each new set of NN interactions that leads to a well-defined and reproducible physical relationship between A and B molecules will give rise to a new component in the measured x-ray powder pattern. Molecules that are close to each other in spatial coordinates may contribute to the measured x-ray powder pattern, for example, in an amount proportional to the number of times this specific spatial arrangement occurs. For a composition, the majority of these new contributions will be unknown. A miscibility determination may be made, however, based on the data collected on the pure phase components and from the composition. As the composition becomes miscible, the x-ray powder patterns on the pure phase components and the composition will also change. For example, in a composition that is initially 30% amorphous API and 70% amorphous stabilizing excipient, if one were to form a 1:1 API:polymer amorphous dispersion, then would see the contribution to the composition's x-ray diffraction pattern from the API essentially disappear and the contribution from the stabilizing excipient diminish to a 40% contribution.

The inventors have surprisingly discovered that by using a statistical model, for example of randomly miscible small-molecule binary compositions (e.g. molecule A and molecule B), it is possible to calculate the quantitative change in the occurrence of the pure A-A molecular interactions and B-B molecular interactions as a function of the amount of A molecules and B molecules in the dispersion. As discussed above, the disorder in amorphous materials is such that at distances much larger than nearest neighbor interactions there is little reproducibility of specific intermolecular interactions, hence there is no well-defined contribution to the analytical data, such as, for example, the measured x-ray powder pattern. Therefore, the miscibility analysis of these materials may focus on the occurrence of NN molecular clusters and their characteristic local NN coordination number.

By way of example, in a dispersion or in a pure phase amorphous material, each individual molecule may be surrounded by at least four neighboring molecules within a particular exemplary 3D matrix in the system. However, these NN molecules will only contribute to specific amorphous halos in an XRPD pattern if well-defined relationships exist in position, conformation, and/or orientation between molecular neighbors. For example, out of the four or more NN molecules in the exemplary 3D matrix, perhaps only a single NN relationship is robust enough to give a reproducible packing relationship and contribute to the measured amorphous halos. Any of the remaining neighboring molecules may, for example, contribute as incoherent single random molecules to the measured powder pattern and thus do not contribute to a measured amorphous halo.

Therefore, in at least certain embodiments of the invention, when one or more of the intermolecular NN relationships that has the potential of breaking when miscibility occurs exists, the degree of miscibility can be determined. The local NN coordination numbers “N_{A}” and “N_{B}”, as used herein, refer to the number of these NN relationships supported by a molecule of type “A” and “B” that break in order for miscibility to occur.

In an exemplary embodiment, in a binary composition where local coordination numbers (N_{A} and N_{B}) for molecules of type A and type B are each four, a representative NN cluster may consist of a local coordination of four molecules around a central molecule. In such a randomly miscible binary composition, for clusters with molecule A as the central molecule, five geometric arrangements of the four NN molecules may occur, as shown in Table 1. Each arrangement can have a finite probability of occurrence depending on the binary composition. This probability is demonstrated in Table 1, assuming the normalized concentration of A is X (and B is 1−X):

TABLE 1
Local coordination of an example system with
four molecules around a central molecule.

| | Number of | |
|---|---|---|
| Molecular | spatial | |
| arrangement | arrangements | Probability |
| A: A A A A | 1 | 1 * X⁵ |
| A: B A A A | 4 | 4 * X⁴ * (1 − X) |
| A: B B A A | 6 | 6 * X³ * (1 − X)² |
| A: B B B A | 4 | 4 * X² * (1 − X)³ |
| A: B B B B | 1 | 1 * X * (1 − X)⁴ |

A similar table can be constructed for clusters with molecule B at the center. The cluster A: AA AA represents local clusters of the pure A reference material and the equivalent cluster B: B B B B represents local clusters of the pure B reference material. For purposes of explanation, all other clusters are assumed to represent mixed NB clusters that form on the occurrence of miscibility. It is also possible that clusters of, for example, type A, break up and the lost A-A NN relationships are not replaced by A-B relationships. This may cause the A molecule to contribute as a random individual molecule to the measured powder pattern. In at least some embodiments, however, this occurrence is of no consequence as it may be the rate at which the A-A relationships and B-B relationships are broken that is being determined. In at least one embodiment, however, the statistical model assumes that lost A-A and B-B relationships are replaced by more favorable A-B relationships.

As a function of the normalized concentration profile X, the probabilities of observing pure A clusters (A-A), pure B clusters (B-B) and clusters with mixed A/B character (A-B) for the same example with local NN coordination numbers N_{A} and N_{B} both equal to four are shown in Table 2:

TABLE 2
Probabilities of observing various cluster
types for an exemplary system.

| X | % (A-A) | % (B-B) | % (A-B) |
|---|---|---|---|
| 0.1 | 59.05 | 0.00 | 40.95 |
| 0.2 | 32.77 | 0.03 | 67.20 |
| 0.3 | 16.81 | 0.24 | 82.95 |
| 0.4 | 7.78 | 1.02 | 91.20 |
| 0.5 | 3.13 | 3.13 | 93.75 |
| 0.6 | 1.02 | 7.78 | 91.20 |
| 0.7 | 0.24 | 16.81 | 82.95 |
| 0.8 | 0.03 | 32.77 | 67.20 |
| 0.9 | 0.00 | 59.05 | 40.95 |

For an exemplary normalized composition X, the total probability of observing A-A, B-B, and A-B is 100%. The presence of the pure A clusters and pure B clusters within a solid dispersion can change as a function of composition. The degree of variability may depend, for example, on the concentration profile and the local molecular coordination number. The coordination number (i.e. N_{A} and N_{B}) and/or the concentration of A clusters, B clusters, and NB clusters can be calculated with the miscibility model shown in equation 7, where c is the calculated concentration in the composition and x is the concentration of the experimentally prepared API:

cᵢ=1=c_{A-A}+c_{B-B}+c_{A-B}=x^{N}^{_{A}}⁺¹+(1−x)^{N}^{_{B}}⁺¹+c_{A-B} (7)

In certain embodiments, the coordination numbers for a phase-separated system may be effectively zero. This gives a linear relationship between the presence of pure phase clusters and the actual binary composition. In such embodiments, it is this linear relationship which is tested using the semi-quantitative analysis.

In various other embodiments, deviation from this linear dependence indicates that the composition is miscible. Thus, for miscible compositions where the coordination number is greater than zero, the degree of miscibility can be characterized by the change in occurrence of pure phase clusters as a function of composition. Therefore, the characterization of miscibility may, in certain embodiments, require the determination of the rate at which the contributions of the pure amorphous phases to the measured powder pattern fall off with change in composition.

In various embodiments of the invention, the output of the miscibility analysis will give the coordination numbers for the API and polymer (N_{A} and N_{B}) which may be carried out by applying a nearest-neighbor refinement method.

In at least one embodiment, the statistical models discussed above may be applied to mixed binary compositions where the A- and B-type molecules are of similar size and have the same local coordination requirements. In this embodiment, each NN configuration is assumed to have the same probability of forming. In various other embodiments, however, the nature of the inter-molecular relationships may be more complex. By way of example, in an indomethacin-PVP system, one of the molecular species is polymeric which can change the allowed NN coordination and make any exact statistical prediction more difficult. It may, for example, depend on the stiffness and degree of unfolding of the polymer chains. The API and polymer may, in various embodiments such as the exemplary indomethacin-PVP system, have different local molecular coordination numbers N_{A} and N_{B}. However, in those cases, the same general concept may still apply with the persistence of the pure phase local clusters as a function of dilution being dependent only upon the effective local molecular coordination numbers (API-API and polymer-polymer).

Coordination numbers may be obtained by applying a nearest-neighbor refinement method. One such method is alternating lease squares (“ALS”) which is an iterative refinement method. ALS may be used to calculate the NN coordination numbers associated with miscible dispersions. Other iterative refinement algorithm methods may also be used to calculate the NN coordination numbers associated with miscible dispersions.

When applying an iterative refinement algorithm method, such as ALS, it may be helpful to apply the following constraints when applying the methods: using non-negative concentrations, using non-negative patterns, and defining the sum of the concentrations of components to equal one (“closure”) when refining the patterns and concentrations. In another useful constraint, the relative amounts of the components (the “concentration”) are fitted into the NN model (equation 7) to find the optimal coordination numbers N_{A} and N_{B}.

Examples of iterative refinement algorithms which may be used as a nearest-neighbor refinement method include ALS and MALS (modified alternating least squares, see Wang, J., Hopke, P. K., Hancewicz, T. M., and Zhang, S., Application of modified alternating least squares regression to spectroscopic image analysis, Anal. Chimica Acta, 476, pp. 93-109 (2003)).

In one embodiment of the invention, ALS is used as a nearest neighbor refinement method and is an iterative refinement algorithm. ALS, as a statistical technique is known in the art and is discussed, for example, in Gemperline, P. and Cash, E in Analytical Chemistry, 75, pp. 4236-4243 (2003), which is incorporated herein by reference which is incorporated herein by reference.

As applied to at least some of the embodiments of the invention, ALS has been applied as follows. For an (m)×(n) data matrix D, it can be expressed as:

D=CS^{T}+E (10)

where C is an (m)×(k) matrix of concentration profiles which store the concentration of API, polymer, and new phase, represented by C_{A}, C_{B}, and C_{A-B}, respectively, and S is an (n)×(k) matrix of data patterns corresponding to the components, where (m) and (n) are as above. The term “k” is the number of pure components in a composition and is equal to three in the miscibility analysis when the number of components is two (for example, A and B). That value may increase from three when the number of pure components increases. When there are two pure components A and B, (k) is three because of the additional component “AB” when the composition is miscible. The term “T” refers to the matrix transpose operation. The matrix E is the residual error and may be, in at least some embodiments, minimized by methods known by those of ordinary skill in the art.

To determine the concentration profile C or patterns S using ALS, an initial estimate of concentrations C₀ or patterns S₀ is needed. The initial estimate of the concentrations and patterns can be obtained, for example, in at least one of four ways: 1) Using PCRM to obtain the C₀ and S₀; 2) using other self-modeling curve resolution (Haqmilton, J. C., and Gemperline, P. J., Mixture analysis using factor analysis. II: self-modeling curve resolution; J. Chemometrics, 4, pp. 1-13 (1990)); 3) some random vectors normalized to unit area for S₀; and 4) the initial estimate of C₀ can also be obtained with initial estimates of N_{A} and N_{B} with the known value x, percentage of API using NN model (equation 7).

Once the initial concentrations C₀ or patterns S₀ have been determined, a nearest neighbor refinement method, such as ALS is applied. In various embodiments of the invention, the ALS method may be applied in the following steps:

Step 1: Find the new patterns Sₙ₊₁ with the Cₙ using non-negative least squares method such as that found in Lawson, C. L., Hanson, R. J., Solving Least Squares Problem, Prentice-Hall, Englewood Cliffs, N.J. (1995), or a fast non-negative least squares method such as that found in Bro, R., Jong, S. D., A Fast Non-Negativity Constrained Least Squares Algorithm, J. Chemometrics, 11, pp. 393-401 (1997). In this step, equation (11) is solved where f⁻¹ represents regression with a non-negativity constraint, the superscript T indicates the matrix transpose operation, and the subscript n represent the number of the iteration. The patterns in Sₙ₊₁ may be normalized to unit area by techniques known to those of ordinary skill in the art.

S_{N+1}=D^{t}F⁻¹(Cₙ) (11)

Step 2: Calculate the new estimate of concentration Cₙ₊₁, expressed in following equation (12):

Cₙ₊₁=Df⁻¹(Sₙ₊₁) (12)

Step 3: Fit the concentration Cₙ₊₁ into the NN model of equation 7. In various embodiments, N_{A} and N_{B} can be obtained by minimizing the error between the concentration profiles calculated from regression and the miscibility model. The miscibility model may be used to create new concentration profiles Cₙ₊₁

Step 4: Repeat step 1-3 until the convergence criterion is reached. Convergence in the ALS procedure may be determined by the relative root-mean-square error (RRMSE, E_{RRMSE}). Other convergence criteria commonly used in the art, such as root mean squared error (RMSE), can also be used for this purpose. The E_{RRMSE} may be obtained from the following equation 13:

$${E}_{RRMSE} = \sqrt{\frac{{\sum }_{i = 1}^{m} {\sum }_{j = 1}^{n} {( {d}_{ij} - {\hat{d}}_{ij} )}^{2}}{{\sum }_{i = 1}^{m} {\sum }_{j = 1}^{n} {d}_{ij}^{2}}} \qquad ( 13 )$$

where subscript i and j represent the case and variable number, respectively. Those of skill in the art will recognize that the ALS procedure converges when the difference in the value of E_{RRMSE} for two consecutive iterations is lower than a threshold value selected by the user. Those of ordinary skill in the art will recognize that for such convergence error measurements, the determination of the threshold value is often influenced by the quality of the data. The higher the data quality, the lower the threshold one can set. The following examples merely illustrate ranges of typical threshold values one might obtains, such as, for example about 1% between, between 0.01% and about 1%, between about 0.1% and about 0.2%, between about 1% and about 10%, between about 1% and about 5%, between about 1% and about 3%, between about 1% and about 2%, and about 2%. With sufficient quality data, much lower numbers can be selected such as 10×10⁻¹ or less. With data of less quality values of 10% or greater may 10% may be chosen.

### EXAMPLES

In the following examples, which are not intended to be limiting of the invention as claimed, the methods of the invention were applied to known datasets using XRPD data.

### A. Sample Preparation

Indomethacin and polyvinylpyrrolidone K90 were obtained from Sigma (St. Louis Mo., USA). Solvents used to prepare dispersions, namely water and dichloromethane were obtained from Mallinckrodt (Phillipsburg N.J., USA) and EMD (Gibbstown N.J., USA), respectively, and used as received.

### Preparation of Amorphous Indomethacin by Quench-Cooling

Amorphous indomethacin was prepared by placing crystalline gamma indomethacin in a glass vial immersed in an oil bath heated to maintain the molten liquid at ˜165° C. The molten liquid was poured into a bath of liquid nitrogen to quench-cool and then ground to a fine powder using a mortar and pestle. The bulk amorphous indomethacin was stored over desiccant at −20° C. until used.

### Preparation of Indomethacin-Polyvinylpyrrolidone Samples

Physical mixtures of powdered amorphous indomethacin prepared by quench-cooling and polyvinylpyrrolidone were prepared by a geometric dilution approach. Sub-parts of each component were added directly to a XRPD holder with a silicon insert and gently stirred. Material addition in this manner was continued until the total weight of each component required to reach the desired composition was achieved.

Dispersions of indomethacin in polyvinylpyrrolidone were prepared at known compositions by flash evaporation from dichloromethane. Solids were dissolved in dichloromethane with stirring. The resulting solution was filtered through a 0.2 μm nylon filter into a 50 mL round bottom flask. The solution was flash evaporated under vacuum with the flask rotated in a water bath maintained at 50° C. Secondary drying of the resulting solids was performed overnight in a vacuum oven maintained at 40° C. Dried samples were stored at −20° C. over desiccant.

### Experimental Procedure—X-Ray Powder Diffraction

XRPD analyses were performed for samples of indomethacin-polyvinylpyrrolidone and the individual components using a Shimadzu XRD-6000 x-ray powder diffractometer (Kyoto, Japan) with Cu Kα radiation. The Shimadzu instrument is equipped with a long fine focus x-ray tube. The tube voltage and amperage were set to 40 kV and 40 mA, respectively. The divergence and scattering slits were set at 1° and the receiving slit was set at 0.15 mm. Diffracted radiation was detected by a Nal scintillation detector. A θ-2θ continuous scan at 1.2°/min from 2.5 to 60° 2θ was used with an effective 0.04 step size (2 s/step). The sample was spun at 30 rpm. The analyses were performed at ambient temperature. A silicon standard was analyzed to check the instrument alignment. Data were collected and analyzed using XRD-6100/7000 v. 5.0. Samples were prepared for analysis by placing them in an aluminum reflection sample holder with low background silicon inserts. The net weight of the sample was recorded in each case. The dimensions of the sample well are approximately 10 mm in diameter and 2 mm in depth.

### Composition Example 1

### IMC:PVP Physical Mixture

A set of physical mixtures of powdered amorphous indomethacin (IMC) and polyvinylpyrrolidone (PVP) was prepared by geometric dilution. The two components were directly added to an XRPD holder with a silicon insert and gently stirred, until the weight of each component reached desired proportions. Table 3 shows a summary of this data set.

TABLE 3
IMC:PVP physical mixture data set.

| | Composition |
|---|---|
| Description | (by weight) |
| Indomethacin | 100% IMC, 0% PVP |
| Polyvinylpyrrolidone | 0% IMC, 100% PVP |
| Mixture #1 | 20% IMC, 80% PVP |
| Mixture #2 | 30% IMC, 70% PVP |
| Mixture #3 | 40% IMC, 60% PVP |
| Mixture #4 | 60% IMC, 40% PVP |
| Mixture #5 | 70% IMC, 30% PVP |
| Mixture #6 | 80% IMC, 20% PVP |

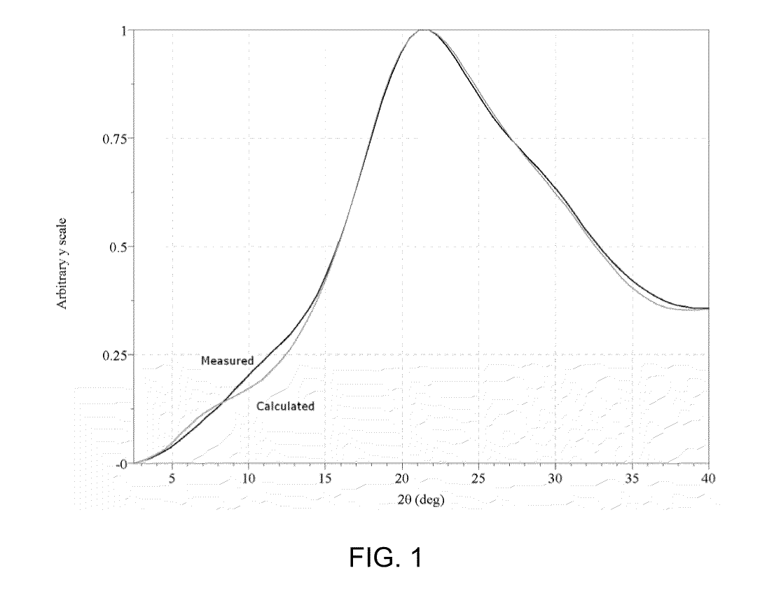

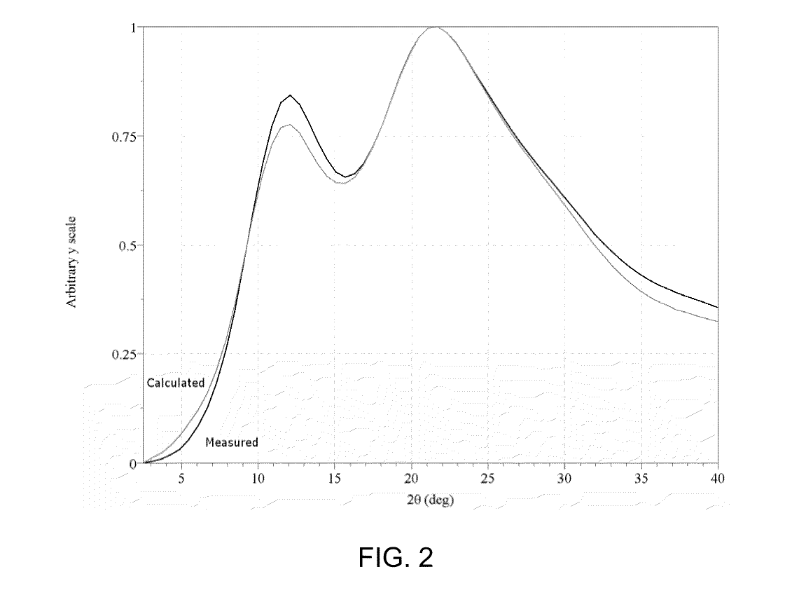

FIG. 1 shows an overlay of the first extracted pure reference curve, compared to the (preprocessed) measured reference pattern of x-ray amorphous IMC. The calculated and measured patterns are in excellent agreement which is consistent with a physical mixture. FIG. 2 shows an overlay of the second extracted pure reference curve compared to the reference pattern of x-ray amorphous PVP. Once again, the patterns are in good agreement with only minor intensity differences in the first amorphous halo which also shows the composition to be a physical mixture. In other words, because no third component was detected and the calculated and measured patterns are in good agreement with each other, a conclusion is reached that the mixtures are phase-separated. The literature has reported physical mixtures of IMC and PVP to be phase separated (Taylor L S, Zografi G, J. Pharm. Res., 14 (12), pp. 1691-1698 (1997)).

### Composition Example 2

Samples of IMC:PVP were prepared by rotary evaporation from dichloromethane solutions. It is known that IMC:PVP dispersions made from solution result in disruption of the IMC dimer found in the gamma form (Yoshioka, M., B. C. Hancock, G. Zografi, J. Pharm. Sci., 84 (8), pp. 983-6 (1995)). This disruption indicates the presence of a miscible dispersion of IMC:PVP. Table 4 shows a summary of this data set.

TABLE 4
IMC:PVP dispersion data set.

| | COMPOSITION |
|---|---|
| DESCRIPTION | (BY WEIGHT) |
| INDOMETHACIN | 100% IMC, 0% PVP |
| POLYVINYLPYRROLIDONE | 0% IMC, 100% PVP |
| DISPERSION #1 | 20% IMC, 80% PVP |
| DISPERSION #2 | 30% IMC, 70% PVP |
| DISPERSION #3 | 40% IMC, 60% PVP |
| DISPERSION #4 | 50% IMC, 50% PVP |
| DISPERSION #5 | 60% IMC, 40% PVP |
| DISPERSION #6 | 70% IMC, 30% PVP |
| DISPERSION #7 | 80% IMC, 20% PVP |

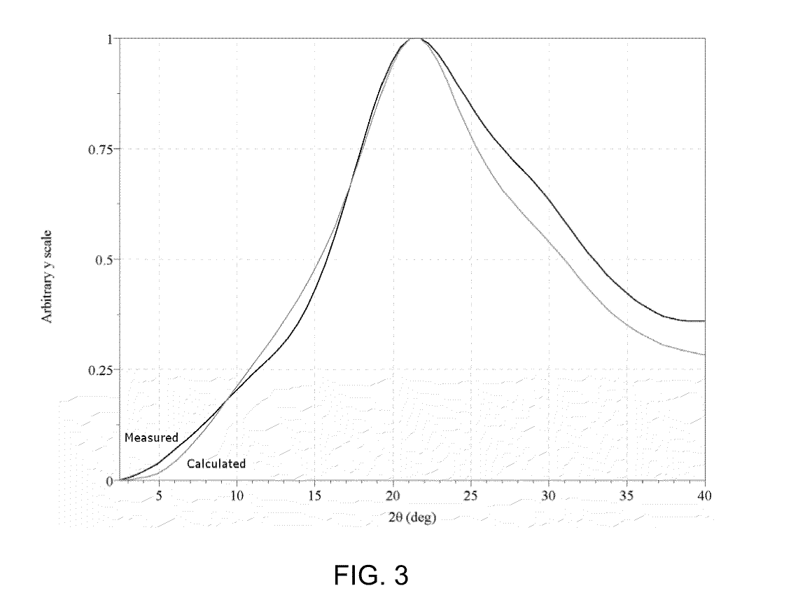

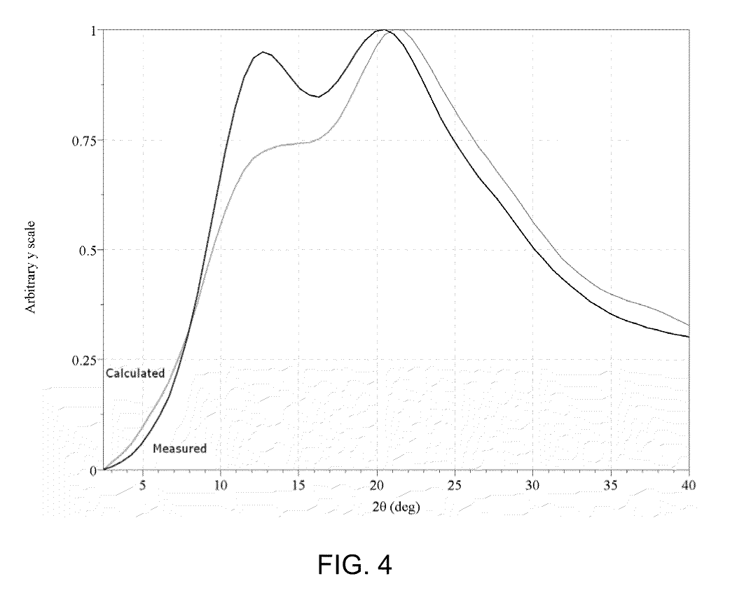

FIG. 3 shows an overlay of the second extracted pure reference curve, compared to the (preprocessed) measured reference pattern of x-ray amorphous IMC. The calculated and measured patterns are in reasonable agreement with respect to primary halo position, but there are some noticeable differences in terms of the width of the primary halo (narrower in calculated than measured data). FIG. 4 shows an overlay of the first extracted pure reference curve compared to the reference pattern of x-ray amorphous PVP. In this case, the x-ray amorphous patterns are very different, both in terms of halo positions and relative intensities. While there was no third component detected, the differences between the calculated and measured patterns are significant pointing to a conclusion that the dispersions are at least partially miscible. As noted above, this result is consistent with previous studies on the IMC:PVP dispersion system. As the dispersion data set is symmetric in a phase-separated composition, the two PRC scale factors are expected to be equivalent.

However, it should be noted that the relative intensity of the lower angle halo of PVP is variable even in the pure PVP phase, being sensitive to the actual preparation techniques used to make the sample. It may be important, therefore, when working with PVP, that the pure phase PVP reference pattern be prepared using the same technique as used to make the dispersion. Even with the method of sample preparation controlled, there are other factors that may influence the lower angle PVP halo, making it potentially unreliable as a sole indicator of miscibility. However, the differences noted between the back-calculated reference pattern using the first pure reference curve and the measured PVP reference pattern go beyond changes in relative intensity in the first halo. For example, a notable change for PVP is in the position of the second halo which moves towards the primary IMC halo occurring at slightly higher angles.

For dispersions comprising the stable gamma polymorph of IMC, the API-API relationships are primarily driven by a hydrogen bonded dimer. In this exemplary dispersion with PVP, the dimer is broken with the IMC hydrogen bond and reformed with PVP. Since single hydrogen bonds drive the local interactions, the expected value of the coherent NN coordination numbers N_{A} and N_{A-B} for IMC-IMC and IMC-PVP will be 1. This assumes that the IMC dimer will preferentially break and re-form with PVP giving a new local molecular coordination.

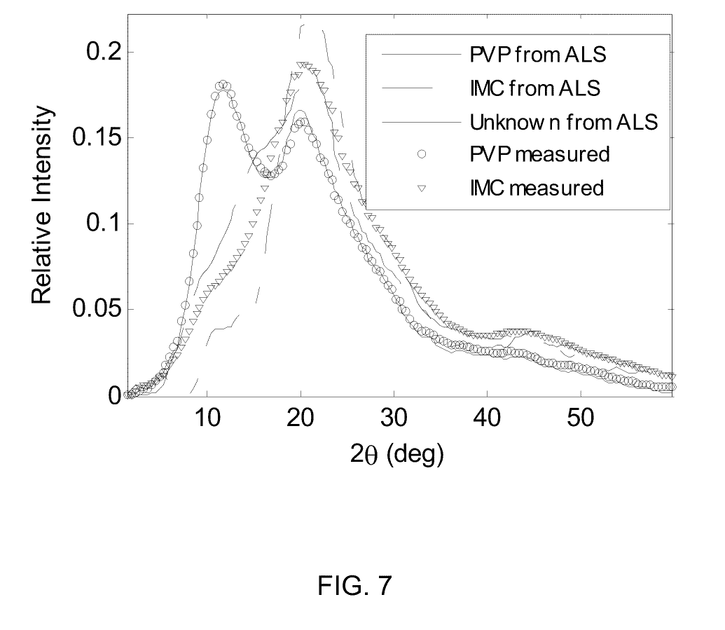

The NN coordination numbers returned by the ALS method within MATLAB were N_{PVP}=1.29 and N_{IMC}=0.92. The residuals calculated from each dispersion (corresponding to the mixed PVP-IMC interaction) were similar in appearance to the IMC reference pattern, as seen in FIG. 7. This similarity introduces some cross correlation in the fitting procedure between the IMC reference and the residual pattern. As such, the IMC NN coordination number calculated using this method is subject to greater error than the coordination number derived for PVP. The NN coordination number results of the minimum residual variance analysis are presented in Table 5.

TABLE 5
Results of NN coordination number analysis

| System | NN # phase 1 | NN # phase 2 |
|---|---|---|
| IMC-PVP (physical | 0.00 | 0.07 |
| mixture) | | |
| IMC-PVP (dispersion) | 0.92 | 1.29 |
| ALS | | |

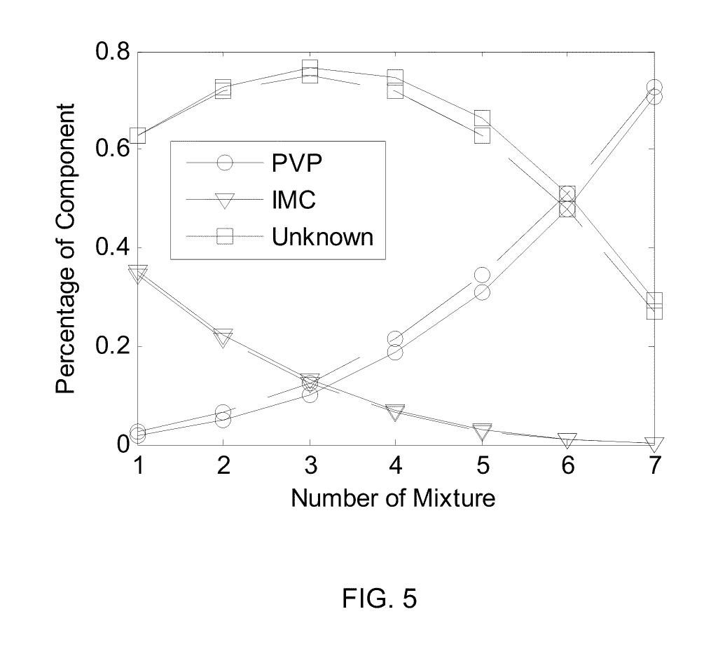

Different starting profiles for the unknown contribution (e.g. the mean of all measured dispersion patterns, or a constant value or the output from the minimum residual variance method), C₀, were tested with similar results. The concentration profiles of PVP, IMC, and the PVP-IMC mixture calculated from measured dispersion data were compared with predicted values based on NN coordination numbers 1 and 1, as seen in FIG. 5. The good match of the concentration profiles to calculated values supports the original hypothesis that the coordination number for PVP and IMC should be 1.0 as predicted for a miscible dispersion dependent on a single hydrogen bond.

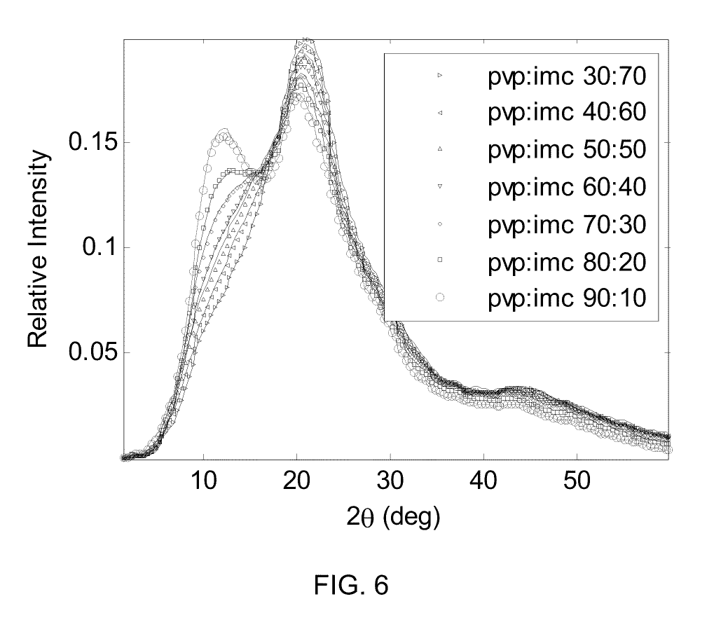

The measured and reconstructed (from the ALS analysis) patterns of the dispersions are given in FIG. 6. Solid lines are the measured patterns of dispersions with different ratios of PVP to IMC. The dotted patterns are calculated using concentrations and patterns extracted during ALS analysis. The ERRMSE is less than 2% at convergence and the threshold value was set to e⁻¹². The reconstructed patterns showed a somewhat larger deviation from the measured patterns at extreme concentration of PVP or IMC (the 70:30 mixture and 10:90 mixtures.). A possible explanation is that as one of the binary components becomes more diluted in the dispersion, any local heterogeneity will more strongly distort the measured response away from the ideal behavior predicted for a randomly dispersed system.

The ALS-calculated patterns of amorphous references for PVP, IMC, and the unknown PVP-IMC interaction are given in FIG. 7. Measured reference patterns of amorphous PVP and IMC are added for comparison. The extracted pattern of PVP agrees with the reference pattern very well, but the extracted pattern of IMC shows a significant difference compared to the reference pattern. Furthermore, the unknown profile corresponding to the contribution from the clusters with mixed character refined to be very close to the pure phase IMC powder pattern.

### Composition Example 3

In this example, a set of physical mixtures of amorphous dextran (DEX) and PVP were prepared. The system was confirmed to be phase-separated by measuring glass transition temperatures (two were found in each case). Table 6 shows a summary of XRPD patterns present in this data set.

TABLE 6
DEX:PVP physical mixture data set.

| | Composition |
|---|---|
| Description | (by weight) |
| Dextran | 100% DEX, 0% PVP |
| Polyvinylpyrrolidone | 0% DEX, 100% PVP |
| Mixture #1 | 30% DEX, 70% PVP |
| Mixture #2 | 70% DEX, 30% PVP |

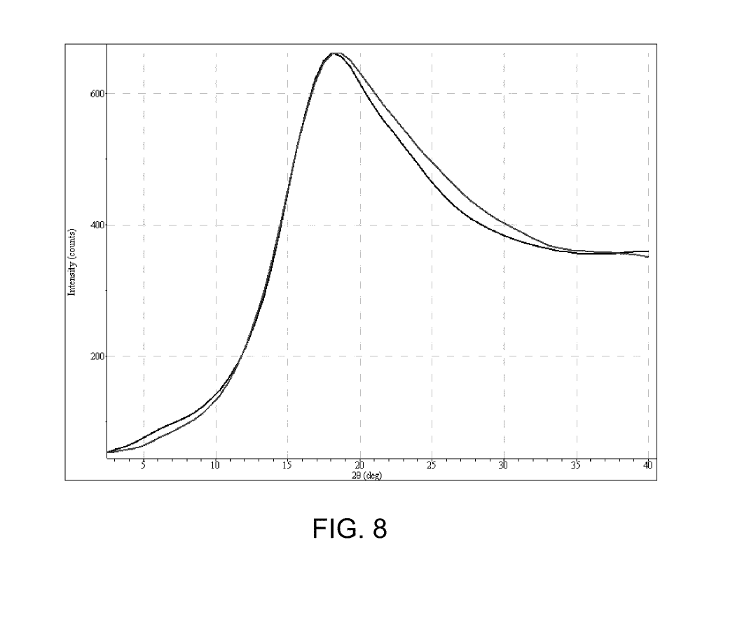

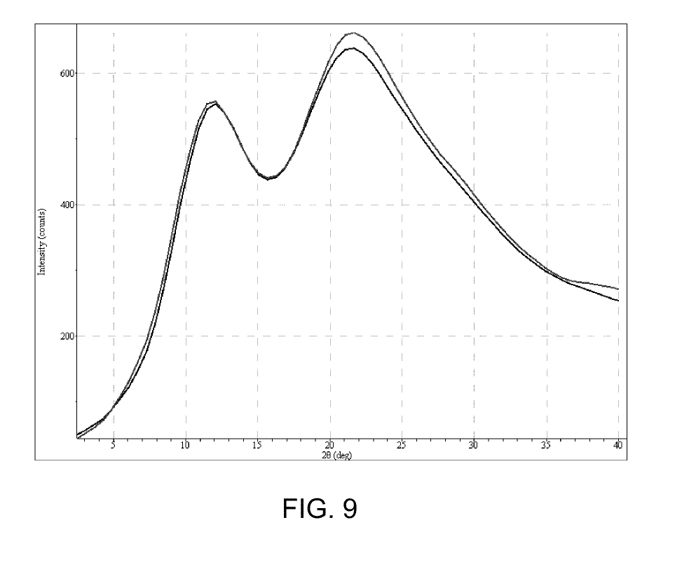

FIG. 8 shows an overlay of the second extracted pure reference curve, compared to the (preprocessed) measured reference pattern of x-ray amorphous DEX. The calculated and measured patterns are in excellent agreement. FIG. 9 shows an overlay of the first extracted pure reference curve compared to the reference pattern of x-ray amorphous PVP. Once again the patterns are in good agreement with only minor intensity differences in the second amorphous halo. Since there was no third component detected and the calculated and measured patterns are in good agreement, a conclusion is reached that the mixtures are phase-separated, a conclusion in agreement with the DSC results.

### Composition Example 4

In this example, a set of lyophilized dispersions of amorphous DEX and PVP were prepared. It is known that the lyophilized samples exhibit two distinct glass transition temperatures, indicating that the samples are phase-separated even after lyophilization. Table 7 shows a summary of XRPD patterns present in this data set.

TABLE 7
DEX:PVP dispersion data set.

| | Composition |
|---|---|
| Description | (by weight) |
| Dextran | 100% DEX, 0% PVP |
| Polyvinylpyrrolidone | 0% DEX, 100% PVP |
| Dispersion #1 | 20% DEX, 80% PVP |
| Dispersion #2 | 30% DEX, 70% PVP |
| Dispersion #3 | 40% DEX, 60% PVP |
| Dispersion #4 | 50% DEX, 50% PVP |
| Dispersion #5 | 60% DEX, 40% PVP |
| Dispersion #6 | 70% DEX, 30% PVP |
| Dispersion #7 | 80% DEX, 20% PVP |

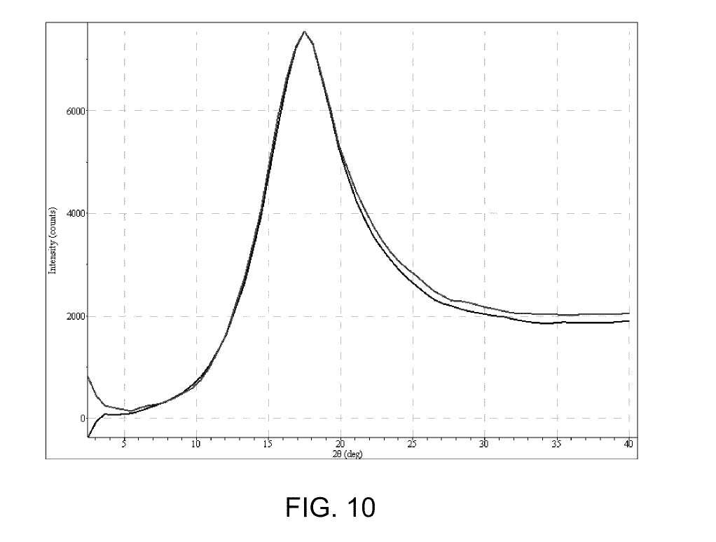

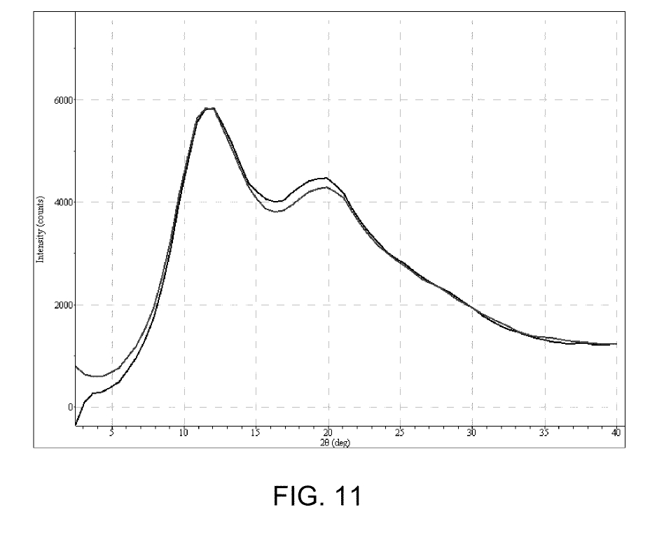

FIG. 10 shows an overlay of the second extracted pure reference curve, compared to the (preprocessed) measured reference pattern of x-ray amorphous DEX. The calculated and measured patterns are in excellent agreement. FIG. 11 shows an overlay of the first extracted pure reference curve compared to the reference pattern of x-ray amorphous PVP. The patterns are in good agreement with only minor intensity differences in the second amorphous halo. Since there was no third component detected and the calculated and measured patterns are in excellent agreement, a conclusion is reached that the dispersions are phase-separated. This is the expected result for two large molecule systems and is consistent our DSC results and previous work on this system.

### Composition Example 5

This example shows a set of dispersions of trehalose (TRE) and DEX, produced by lyophilization of an aqueous solution. While this system initially exhibits a single glass transition temperature, previous computational analysis determined it was phase-separated. Indeed, studies on this material have shown that even though an initial T_{g} value is observed, two T_{g} values are observed upon stressing the sample prior to eventual crystallization of the TRE. Table 8 shows a summary of XRPD patterns present in this data set.

TABLE 8
DEX:TRE dispersion data set.

| | Composition |
|---|---|
| Description | (by weight) |
| Dextran | 100% DEX, 0% TRE |
| Trehalose | 0% DEX, 100% TRE |
| Dispersion #1 | 20% DEX, 80% TRE |
| Dispersion #2 | 30% DEX, 70% TRE |
| Dispersion #3 | 40% DEX, 60% TRE |
| Dispersion #4 | 50% DEX, 50% TRE |
| Dispersion #5 | 60% DEX, 40% TRE |
| Dispersion #6 | 70% DEX, 30% TRE |
| Dispersion #7 | 80% DEX, 20% TRE |

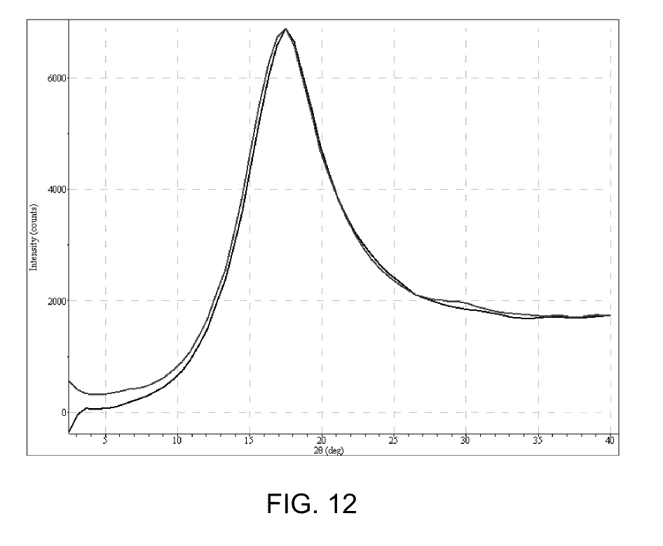

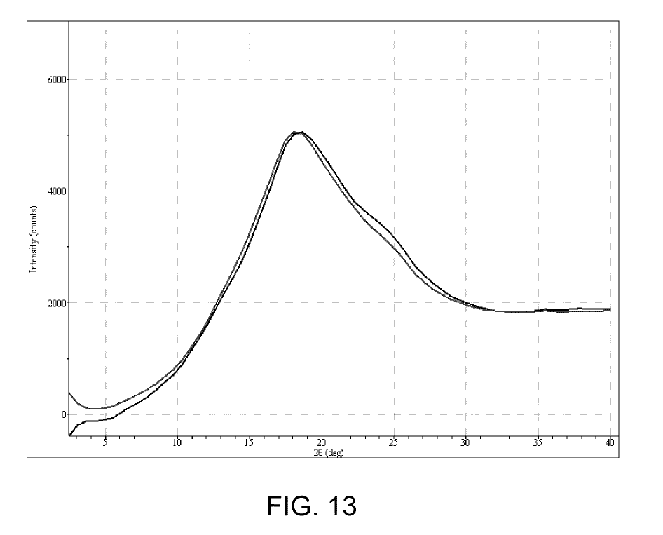

FIG. 12 shows an overlay of the first extracted pure reference curve, compared to the (preprocessed) measured reference pattern of x-ray amorphous DEX. The calculated and measured patterns are in excellent agreement. FIG. 13 shows an overlay of the second extracted pure reference curve compared to the reference pattern of x-ray amorphous TRE. The patterns are in excellent agreement. Since there was no third component detected and the calculated and measured patterns are in excellent agreement, a conclusion is reached that the dispersions are phase-separated. As is known, the TRE:DEX dispersion represents a class of dispersions sometimes referred to as “nano-suspensions.” For these systems, a single T_{g} is observed but the x-ray diffraction measurements clearly show phase separation. Thus, the PCRM method is helpful for analyzing such a system.

1. A method for analyzing a composition wherein at least one component is amorphous, said method comprising extracting information for individual components of the composition from measured analytical data; generating resulting data using a pure curve resolution method; and analyzing the resulting data by a nearest neighbor refinement method to determine the nearest-neighbor coordination number for the components of the composition.

2. The method of claim 1, wherein the composition comprises an active pharmaceutical ingredient and at least one stabilizing excipient.

3. The method of claim 2, wherein active pharmaceutical ingredient and the at least one stabilizing excipient are amorphous.

4. The method of claim 3, wherein the analytical data and the resulting data are x-ray powder diffraction data.

5. The method of claim 4, wherein the composition is a dispersion.

6. The method of claim 4, comprising collecting analytical data on the composition; obtaining analytical reference data for each of the components of the composition; applying a pure curve resolution method to the analytical data collected on the composition and on the analytical reference data to generate resulting data; and analyzing the resulting data to determine whether the composition is miscible or phase separated.

7. The method of claim 6, wherein the analytical reference data are x-ray powder diffraction data.

8. The method of claim 7, wherein the determination of whether a composition is miscible or phase separated is performed by assessing whether the pure reference curve data agrees with the reference data for the components of the composition.

9. The method of claim 7, where the agreement is done by a method selected from visual matching, a sum squared difference approach, or by use of pattern matching software.

10. The method of claim 9, wherein the pure curve resolution method comprises:
a. calculating the mean of each variable μ, where (m) and (n) are in a data matrix (m)×(n) where (m) is the number of cases and (n) is the number of points in each data set d_{i,j} is the mean-centered intensity calculated by
$${μ}_{j} = \frac{1}{m} {\sum }_{i = 1}^{m} {d}_{i , j} as defined herein ;$$
b. calculating the mean centered intensity by
d*_{i,j}==d_{i,j}−μⱼ as defined herein;
c. calculating the standard deviation by
$${σ}_{j} = \sqrt{\frac{{\sum }_{i = 1}^{m} {( {d}_{i , j}^{*} )}^{2}}{m - 1}} as defined herein ;$$
d. calculating the maximum standard deviation in step c and select data points (j) associated with that maximum;
e. calculating a data set for each pure reference curve with the maximum found in step d;
f. removing the standard deviation associated with the last pure reference curve from the remaining standard deviations;
g. computing the ratio of remaining standard deviations to the initial standard deviations;
h. repeating steps e-g until the ratio in step g is small; and
i. calculating data points associated with the pure reference
$$curve by {y}_{j} = {μ}_{j} - {s}_{k} * ( {σ}_{j} ( {PRC}_{k} ) - {\sum }_{i = 1 , i \neq k}^{l} {σ}_{j} ( {PRC}_{i} ) ) ,$$
as defined herein.

11. The method of claim 10, wherein the ratio in step h about 0.2.

12. The method of claim 10, wherein the ratio in step h is between about 0.01 and about 0.2.

13. The method of claim 10, wherein the ratio in step h is between about 10×10⁻¹ and about 0.2.

14. The method of claim 13, wherein the data set for each pure reference curve is calculated according to the following method:
calculating correlation coefficients by
$$Correl ( {d}_{i , j}^{*} , {d}_{i , PC}^{*} ) = \frac{{\sum }_{i = 1}^{m} ( {d}_{i , j}^{*} * {d}_{i , PC}^{*} )}{\sqrt{{( {d}_{i , j}^{*} )}^{2} {( {d}_{i , PC}^{*} )}^{2}}} ,$$
as defined herein;
calculating a standard deviation associated with the pure reference curve by
σⱼ(PRC)=σⱼ*(Correlⱼ+1)/2, as defined herein; and
calculating data points associated with the pure reference curve by
$${y}_{j} = {μ}_{j} - {s}_{k} * ( {σ}_{j} ( {PRC}_{k} ) - {\sum }_{i = 1 , i \neq k}^{l} {σ}_{j} ( {PRC}_{i} ) ) ,$$
as defined herein.

15. The method of claim 14, wherein the nearest neighbor refinement method is alternating least squares.

16. A method for calculating coordination numbers in a dispersion comprising the steps of:
a. estimating the concentrations and data patterns corresponding to the components of the dispersion;
b. determining new data patterns by
Sₙ₊₁=D^{T}f⁻¹(Cₙ), as defined herein;
c. determining new concentrations by
Cₙ₊₁=Df⁻¹(Sₙ₊₁), as defined herein;
d. fitting the concentration Cₙ₊₁ into the following:
$${c}_{I} = 1 = {c}_{A - A} + {c}_{B - B} + {c}_{A - B} = {x}^{{N}_{A} + 1} + {( 1 - x )}^{{N}_{B} + 1} + {c}_{A - B}$$
to obtain coordination numbers; and
e. repeating steps b-d until convergence is obtained.

17. The method of claim 16, wherein the data patterns are x-ray powder diffraction patterns.

18. The method of claim 17, wherein step a is performed by a pure curve resolution method.

19. The method of claim 16, wherein convergence is obtained from the following:
$${E}_{RRMSE} = \sqrt{\frac{{\sum }_{i = 1}^{m} {\sum }_{j = 1}^{n} {( {d}_{ij} - {\hat{d}}_{ij} )}^{2}}{{\sum }_{i = 1}^{m} {\sum }_{j = 1}^{n} {d}_{ij}^{2}}}$$
wherein the difference between two consecutive iterations differ by less than about 1%.

20. The method of claim 1, wherein the pure curve resolution method comprises:
a. calculating the mean of each variable μ, where (m) and (n) are in a data matrix (m)×(n) where (m) is the number of cases and (n) is the number of points in each data set d_{i,j} is the mean-centered intensity calculated by
$${μ}_{j} = \frac{1}{m} {\sum }_{i = 1}^{m} {d}_{i , j} as defined herein ;$$
b. calculating the mean centered intensity by
d*_{i,j}=d_{i,j}−μⱼ as defined herein;
c. calculating the standard deviation by
$${σ}_{j} = \sqrt{\frac{{\sum }_{i = 1}^{m} {( {d}_{i , j}^{*} )}^{2}}{m - 1}} as defined herein ;$$
d. calculating the maximum standard deviation in step c and select data points (j) associated with that maximum;
e. calculating a data set for each pure reference curve with the maximum found in step d;
f. removing the standard deviation associated with the last pure reference curve from the remaining standard deviations;
g. computing the ratio of remaining standard deviations to the initial standard deviations;
h. repeating steps e-g until the ratio in step g is small; and
i. calculating data points associated with the pure reference
$$curve by {y}_{j} = {μ}_{j} - {s}_{k} * ( {σ}_{j} ( {PRC}_{k} ) - {\sum }_{i = 1 , i \neq k}^{l} {σ}_{j} ( {PRC}_{i} ) ) ,$$
as defined herein.
